(19) United States
(12) Patent Application Publication
(10) Pub. No.: US 2025/0079506 A1
(43) Pub. Date: Mar. 6, 2025

(54) ALL-SOLID-STATE BATTERY

(71) Applicant: TOYOTA JIDOSHA KABUSHIKI KAISHA, Toyota-shi (JP)

(72) Inventors: Shinya Shiotani, Nagoya-shi (JP); Ryo Asakura, Shizuoka-ken (JP); Sakina Kaneko, Fujisawa-shi (JP)

(73) Assignee: TOYOTA JIDOSHA KABUSHIKI KAISHA, Toyota-shi (JP)

(21) Appl. No.: 18/668,436

(22) Filed: May 20, 2024

(30) Foreign Application Priority Data
Sep. 5, 2023 (JP) 2023-143823

(51) Int. Cl. H01M 10/0562

(52) U.S. Cl. CPC H01M 10/0562; H01M 2300/0068; H01M 2300/0094

(57) ABSTRACT

An all-solid-state battery has a negative electrode current collector, a solid electrolyte layer A containing a first sulfide solid electrolyte and a second sulfide solid electrolyte, a solid electrolyte layer B containing a third sulfide solid electrolyte, and a positive electrode active material layer, the first sulfide solid electrolyte has a reduction peak at 0.3 V (vsLi/Li⁺) or more and 1.0 V (vsLi/Li⁺) or less in a cyclic voltammetry measurement, and contains an M element, the second sulfide solid electrolyte is a sulfide solid electrolyte having no reduction peak at 0.3 V (vsLi/Li⁺) or more and 1.0 V (vsLi/Li⁺) or less in the cyclic voltammetry measurement, and in the solid electrolyte layer A, the proportion of the first sulfide solid electrolyte in relation to the total weight of the first sulfide solid electrolyte and the second sulfide solid electrolyte is more than 0 wt % and 45 wt % or less.

### CROSS-REFERENCE TO RELATED APPLICATION

This application claims priority to Japanese Patent Application No. 2023-143823 filed on Sep. 5, 2023, incorporated herein by reference in its entirety.

### BACKGROUND

### 1. Technical Field

The present disclosure relates to all-solid-state batteries.

### 2. Description of Related Art

All-solid-state batteries are batteries including a solid electrolyte layer between a positive electrode active material layer and a negative electrode active material layer, and are advantageous in that a safety device can be easily simplified compared to liquid batteries including an electrolyte solution containing a flammable organic solvent. Batteries using a precipitation-dissolution reaction of metallic lithium as a negative electrode reaction are known in the field of all-solid-state batteries.

For example, Japanese Unexamined Patent Application Publication No. 2021-89814 (JP 2021-89814 A) discloses an all-solid-state battery using a precipitation-dissolution reaction of metallic lithium as a negative electrode reaction. This all-solid-state battery includes a negative electrode current collector, an Li storage layer containing a spherical carbon material and a resin, a metal M layer containing a metal M that can be alloyed with lithium, a solid electrolyte layer, and a positive electrode layer in this order. The thickness of the metal M layer is 30 nm or more and 5 μm or less.

### SUMMARY

In all-solid-state batteries using a precipitation-dissolution reaction of metallic lithium as a negative electrode reaction, a typical negative electrode active material layer is usually not provided at the time of manufacturing the all-solid-state battery, and a negative electrode active material layer (Li-containing layer) is formed by initial charge. Therefore, these all-solid-state batteries are advantageous in that the manufacturing process can be easily simplified and the energy density can be easily improved. The typical negative electrode active material layer is a layer containing negative electrode active material particles that store and release Li. From the viewpoint of improving the energy density and the battery performance, there is a demand for all-solid-state batteries having both a simplified battery structure and improved cycle characteristics.

The present disclosure was made in view of the above circumstances, and it is an object of the present disclosure to provide an all-solid-state battery having both a simplified battery structure and improved cycle characteristics.

An all-solid-state battery according to an aspect of the present disclosure is an all-solid-state battery using a precipitation-dissolution reaction of metallic lithium as a negative electrode reaction.
The all-solid-state battery includes a negative electrode current collector, a solid electrolyte layer A, a solid electrolyte layer B, and a positive electrode active material layer in this order in a thickness direction.
The solid electrolyte layer A contains a first sulfide solid electrolyte and a second sulfide solid electrolyte.
The solid electrolyte layer B contains a third sulfide solid electrolyte.
The first sulfide solid electrolyte is a sulfide solid electrolyte having a reduction peak at 0.3 V (vsLi/Li⁺) or more and 1.0 V (vsLi/Li⁺) or less in a cyclic voltammetry measurement. The first sulfide solid electrolyte contains an M element (M is at least one of the following elements: Sn, Al, Zn, In, Ge, Si, Sb, Ga, and Bi).
The second sulfide solid electrolyte is a sulfide solid electrolyte having no reduction peak at 0.3 V (vsLi/Li⁺) or more and 1.0 V (vsLi/Li⁺) or less in the cyclic voltammetry measurement. In the solid electrolyte layer A, a proportion of the first sulfide solid electrolyte in relation to a total weight of the first sulfide solid electrolyte and the second sulfide solid electrolyte is more than 0 wt % and 45 wt % or less.

In the all-solid-state battery of the above aspect,
in the solid electrolyte layer A, the proportion of the first sulfide solid electrolyte in relation to the total weight of the first sulfide solid electrolyte and the second sulfide solid electrolyte may be 5 wt % or more and 40 wt % or less.

In the all-solid-state battery of the above aspect,
the third sulfide solid electrolyte may be a sulfide solid electrolyte having no reduction peak at 0.3 V (vsLi/Li⁺) or more and 1.0 V (vsLi/Li⁺) or less in the cyclic voltammetry measurement.

In the all-solid-state battery of the above aspect,
the first sulfide solid electrolyte may contain an Li element, the M element, and an S element, and
the M element may be at least one of the following elements: Sn, Al, Zn, and In.

In the all-solid-state battery of the above aspect,
the all-solid-state battery may include a protective layer between the negative electrode current collector and the solid electrolyte layer A, the protective layer containing Li and the M.

The all-solid-state battery according to the present disclosure is advantageous in that it has both a simplified battery structure and improved cycle characteristics.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating an all-solid-state battery according to the present disclosure;

FIG. 2 is a schematic cross-sectional view illustrating an all-solid-state battery in the present disclosure;

FIG. 3 is a schematic cross-sectional view illustrating an all-solid-state battery according to the present disclosure; and

FIG. 4 shows the results of capacity retention rates in the cells prepared in Examples 1 to 3, Comparative Examples 1 to 5, and Reference Examples 1 to 3.

### DETAILED DESCRIPTION OF EMBODIMENTS

Hereinafter, an all-solid-state battery according to the present disclosure will be described in detail with reference to the drawings. Each drawing shown below is schematically shown, and the size and shape of each part are appropriately exaggerated for easy understanding.

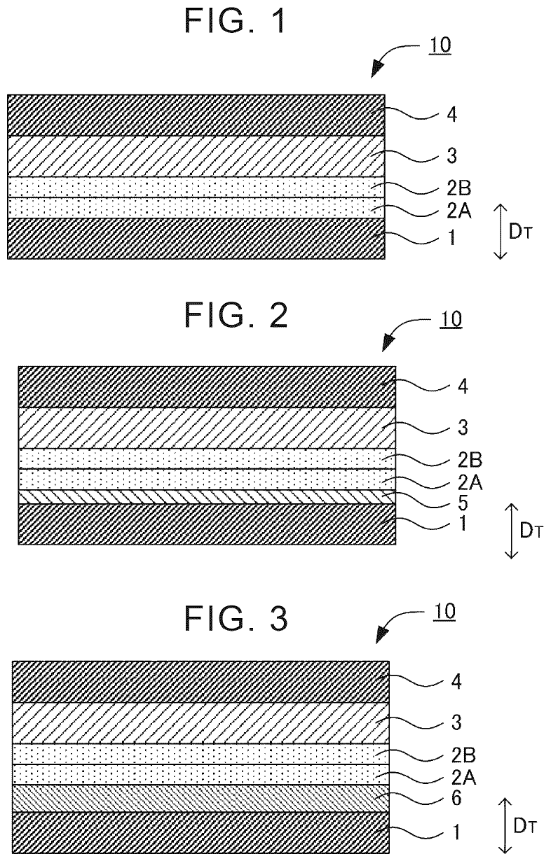

FIG. 1 and FIG. 2 are schematic cross-sectional views illustrating an all-solid-state battery according to the present disclosure. More specifically, FIG. 1 illustrates an all-solid-state battery before initial charging, and FIG. 2 illustrates an all-solid-state battery after initial charging. The all-solid-state battery 10 illustrated in FIG. 1 includes a negative electrode current collector 1, a solid electrolyte layer 2A (solid electrolyte layer A), a solid electrolyte layer 2B (solid electrolyte layer B), a positive electrode active material layer 3, and a positive electrode current collector 4 in this order in the thickness direction DT. The solid electrolyte layer 2A contains a first sulfide solid electrolyte having a relatively low reduction resistance and a second sulfide solid electrolyte having a relatively high reduction resistance at a predetermined ratio. The solid electrolyte layer 2B contains a third sulfide solid electrolyte. On the other hand, as shown in FIG. 2, when the all-solid-state battery 10 shown in FIG. 1 is charged, a protective layer 5 including Li and M (a particular metallic element included in the first sulfide solid electrolyte) is formed between the negative electrode current collector 1 and the solid electrolyte layer 2A.

In the present disclosure, in a battery using a precipitation-dissolution reaction of metallic lithium as a negative electrode reaction, two types of sulfide solid electrolytes, a first sulfide solid electrolyte having a relatively low reduction resistance and a second sulfide solid electrolyte having a relatively high reduction resistance, are used for the solid electrolyte layer A. Accordingly, the battery of the present disclosure is an all-solid-state battery having both a simplified battery structure and improved cycle characteristics. In addition, the solid electrolyte layer has the solid electrolyte layer A and the solid electrolyte layer B, and the solid electrolyte layer A greatly contributes to improvement in cycle characteristics. Therefore, the range of material selection of the solid electrolyte layer B is widened, and for example, by selecting the third sulfide solid electrolyte having relatively high reduction resistance, the cycle characteristics can further be improved. In general, when the sulfide solid electrolyte is reduced and decomposed, the ion conductivity is remarkably lowered, and therefore, a material having high reduction resistance is used for the sulfide solid electrolyte used in the solid electrolyte layer. In particular, in a battery using a precipitation-dissolution reaction of metallic lithium as a negative electrode reaction, for example, a sulfide solid electrolyte having excellent reduction resistance has been conventionally used because the reaction potential of the negative electrode is lower than that of a battery using a graphite-based active material as a negative electrode active material.

On the other hand, in the present disclosure, in addition to the sulfide solid 5 electrolyte (second sulfide solid electrolyte) having excellent reduction resistance, a sulfide solid electrolyte (first sulfide solid electrolyte) having lower reduction resistance than the second sulfide solid electrolyte is used at a predetermined ratio. Combining the first sulfide solid electrolyte and the second sulfide solid electrolyte unexpectedly provides a great advantage that the cycle characteristics are improved compared to the case where the second sulfide solid electrolyte with high reduction resistance is used alone. The reason for the improvement in cycling properties is presumed to be that the first sulfide solid electrolyte contains a particular M element, so that a LiM alloy is formed as a decomposition product of the first sulfide solid electrolyte, and LiM alloy thus formed functions as a protective layer. The protective layer protects the decomposition of the sulfide solid electrolyte. In addition, since the protective layer derived from the first sulfide solid electrolyte is formed, it is not necessary to provide another protective layer in order to protect the solid electrolyte layer, or it is possible to reduce the thickness of another protective layer. Therefore, it is possible to achieve both a simplified battery structure and improved cycle characteristics.

### 1. Solid Electrolyte Layer

The solid electrolyte layer includes a solid electrolyte layer A and a solid electrolyte layer B in this order from the negative electrode current collector side. The solid electrolyte layer A and the solid electrolyte layer B are usually layers having different compositions.

### (1) Solid Electrolyte Layer A

The solid electrolyte layer A contains, as the sulfide solid electrolyte, a first sulfide solid electrolyte and a second sulfide solid electrolyte. The sulfide solid electrolyte is usually a solid electrolyte containing sulfur(S) as a main component of an anionic element.

### (i) First Sulfide Solid Electrolyte

The first sulfide solid electrolyte is a sulfide solid electrolyte having a lower reduction resistance than a second sulfide solid electrolyte described later. Specifically, the first sulfide solid electrolyte has a reduction peak at 0.3 V (vsLi/Li⁺) or more and 1.0 V (vsLi/Li⁺) or less in a cyclic voltammetry measurement. A reduction reaction caused by an M element that is a metal element described later usually occurs in the potential range of 0.3 V (vsLi/Li⁺) or more and 1.0 V (vsLi/Li⁺) or less. When the first sulfide solid electrolyte contains a P element that is a nonmetallic element, a reduction reaction due to the P element may occur at a potential higher than 1.0 V (vsLi/Li⁺). The upper limit is set to 1.0 V (vsLi/Li⁺) or more in order to eliminate the influence of a P element. Details of the cyclic voltammetry measurement will be described in the following examples.

The first sulfide solid electrolyte may be a glass-based (amorphous-based) sulfide solid electrolyte, a glass-ceramic-based sulfide solid electrolyte, or a crystalline sulfide solid electrolyte.

The first sulfide solid electrolyte usually contains an Li element, an M element (M is at least one of Sn, Al, Zn, In, Ge, Si, Sb, Ga, and Bi), and an S element. Each of the M elements is an element that can be alloyed with Li. The first sulfide solid electrolyte preferably further contains a P element. The first sulfide solid electrolyte may contain a halogen element such as F, Cl, Br, or I. In addition, in the first sulfide solid electrolyte, a part of the S element may be substituted with an O element.

The first sulfide solid electrolyte may have a crystalline phase. Examples of the crystalline phase include a LGPS crystalline phase, a Thio-LISICON crystalline phase, and an aldilodite crystalline phase.

The composition of the first sulfide solid electrolyte is not particularly limited, and examples thereof include Li₄₋ₓSn₁₋ₓPₓS₄ (0<x<1). At least a portion of Sn may be substituted with at least one of Al, Zn, In, Ge, Si, Sb, Ga, and Bi. Similarly, at least a portion of P may be substituted with at least one of Al, Zn, In, Ge, Si, Sb, Ga, and Bi. A part of Li may be substituted with at least one of Na, K, Mg, Ca, and Zn. Furthermore, part of S may be substituted with halogen (F, Cl, Br, I) or oxygen (O).

Other examples of the composition of the first sulfide solid electrolyte include xLi₂S-(1−x)SnS₂-yLiX (0<x<1, 0≤y<1, X is one or more halogens). At least a portion of Sn may be substituted with at least one of Al, Zn, In, Ge, Si, Sb, Ga, and Bi. A part of Li may be substituted with at least one of Na, K, Mg, Ca, and Zn. Furthermore, part of S may be substituted with oxygen (O).

The shape of the first sulfide solid electrolyte is, for example, particulate. The average particle size of the first sulfide solid electrolyte is, for example, 0.5 μm or more and 30 μm or less. As used herein, the mean particle size refers to the volume cumulative particle size D₅₀ as measured by a laser diffraction-scattering particle size analyzer.

### (ii) Second Sulfide Solid Electrolyte

The second sulfide solid electrolyte is a sulfide solid electrolyte having a higher reduction resistance than the first sulfide solid electrolyte. Specifically, the first sulfide solid electrolyte having no reduction peak at 0.3 V (vsLi/Li⁺) or more and 1.0 V (vsLi/Li⁺) or less in the cyclic voltammetry measurement.

The second sulfide solid electrolyte may be a glass-based (amorphous-based) sulfide solid electrolyte, a glass-ceramic-based sulfide solid electrolyte, or a crystal-based sulfide solid electrolyte.

The second sulfide solid electrolyte usually contains at least an Li element and an S element. The second sulfide solid electrolyte preferably further contains a P element. The second sulfide solid electrolyte may contain a halogen element such as F, Cl, Br, or I. The second sulfide solid electrolyte may contain an O element. The second sulfide solid electrolyte preferably does not contain a metal element other than Li. However, the second sulfide solid electrolyte may contain a metal element other than Li as long as the reduction resistance is not affected.

The second sulfide solid electrolyte may have a crystalline phase. Examples of the crystalline phase include a Thio-LISICON type crystalline phase, an argyrodite type crystalline phase, and a LGPS type crystalline phase.

The composition of the second sulfide solid electrolyte is not particularly limited. However, examples of the second sulfide solid electrolyte include xLi₂S·(1−x)P₂S₅ (0.5≤x<1), yLiI·zLiBr·(100−y−z)(xLi₂S·(1−x)P₂S₅) (0.5≤x<1, 0≤y≤30, and 0≤z≤30). In these compositions, x preferably satisfies 0.7≤x≤0.8. In these embodiments, a part of Li may be substituted with at least one of Na, K, Mg, Ca, and Zn. Furthermore, part of S may be substituted with oxygen (O).

Other examples of the second sulfide solid electrolyte include Li_{7-x-2y}PS_{6-x-y}X_{y}. X is at least one of F, Cl, Br, and I, and x and y satisfy 0≤x and 0≤y. A portion of Li may be substituted with at least one of Na, K, Mg, Ca, and Zn. Furthermore, part of S may be substituted with oxygen (O).

The shape of the second sulfide solid electrolyte is, for example, particulate. The average particle size of the second sulfide solid electrolyte is, for example, 0.5 μm or more and 30 μm or less.

(iii) Solid Electrolyte Layer A

The solid electrolyte layer A contains a first sulfide solid electrolyte and a second sulfide solid electrolyte. In the solid electrolyte layer A, the first sulfide solid electrolyte and the second sulfide solid electrolyte are preferably uniformly dispersed. In addition, in the solid electrolyte layer A, the proportion of the first sulfide solid electrolyte in relation to the total weight of the first sulfide solid electrolyte and the second sulfide solid electrolyte is more than 0 wt % and 45 wt % or less. The proportion of the first sulfide solid electrolyte may be 1 wt % or more, 3 wt % or more, or 5 wt % or more. On the other hand, the proportion of the first sulfide solid electrolyte may be 40 wt % or less, or may be 30 wt % or less. The proportion of the first sulfide solid electrolyte may be near 10 wt % (5 wt % or more and 15 wt % or less). In the solid electrolyte layer A, the total proportion of the first sulfide solid electrolyte and the second sulfide solid electrolyte is, for example, 80 wt % or more, and may be 90 wt % or more, or may be 95 wt % or more.

The solid electrolyte layer A may contain a binder. Examples of the binder include rubber-based binders such as butylene rubber (BR) and styrene-butadiene rubber (SBR), and fluoride-based binders such as polyvinylidene fluoride (PVDF). The thickness of the solid electrolyte layer A is, for example, 0.5 μm or more and 250 μm or less.

### (2) Solid Electrolyte Layer B

The solid electrolyte layer B contains a third sulfide solid electrolyte as a sulfide solid electrolyte. The solid electrolyte layer B may contain one type or two or more types of third sulfide solid electrolytes.

The third sulfide solid electrolyte may be a sulfide solid electrolyte α having a reduction peak at 0.3 V (vsLi/Li⁺) or more and 1.0 V (vsLi/Li⁺) or less in the cyclic voltammetry measurement like the first sulfide solid electrolyte. The solid electrolyte layer B may not contain the sulfide solid electrolyte α.

The third sulfide solid electrolyte may be a sulfide solid electrolyte β having no reduction peak at 0.3 V (vsLi/Li⁺) or more and 1.0 V (vsLi/Li⁺) or less in the cyclic voltammetry measurement like the second sulfide solid electrolyte. The solid electrolyte layer B may not contain the sulfide solid electrolyte β.

The solid electrolyte layer B may contain both the sulfide solid electrolyte α and the sulfide solid electrolyte β as the third sulfide solid electrolyte. In this case, the proportion of the sulfide solid electrolyte α in relation to the total weight of the sulfide solid electrolyte α and the sulfide solid electrolyte β is defined as R_{B} (wt %). In the solid electrolyte layer A, the proportion of the first sulfide solid electrolyte in relation to the total weight of the first sulfide solid electrolyte and the second sulfide solid electrolyte is defined as R_{A} (wt %). Preferably, R_{A} is greater than R_{B}. The difference between R_{A} and R_{B} is preferably, for example, 3 wt % or more.

The third sulfide solid electrolyte may be a glass-based (amorphous-based) sulfide solid electrolyte, a glass-ceramic-based sulfide solid electrolyte, or a crystal-based sulfide solid electrolyte. The details of the third sulfide solid electrolyte are the same as those described for the first sulfide solid electrolyte and the second sulfide solid electrolyte.

The solid electrolyte layer B may be composed of a single layer or a plurality of layers. In the entire solid electrolyte layer, one or more solid electrolyte layers located on the positive electrode side of the solid electrolyte layer A correspond to the solid electrolyte layer B.

In the solid electrolyte layer B, the proportion of the third sulfide solid electrolyte is, for example, 80 wt % or more, and may be 90 wt % or more, or may be 95 wt % or more. The solid electrolyte layer B may contain a binder. Examples of the binder include rubber-based binders such as butylene rubber (BR) and styrene-butadiene rubber (SBR), and fluoride-based binders such as polyvinylidene fluoride (PVDF). The thickness of the solid electrolyte layer B is, for example, 0.5 μm or more and 250 μm or less. The thickness of the solid electrolyte layer B is, for example, relative to the thickness of the solid electrolyte layer A, 1.0 time or more, may be 1.5 times or more, may be 2.0 times or more.

### 2. Positive Electrode

The positive electrode in the present disclosure includes a positive electrode current collector and a positive electrode active material layer. The positive electrode active material layer contains at least a positive electrode active material. The positive electrode active material layer may contain at least one of a solid electrolyte, a conductive material, and a binder.

Examples of the positive electrode active material include an oxide active material. Examples of the oxide active material include rock salt-type layered active materials such as LiCoO₂, LiNi_{1/3}Co_{1/3}Mn_{1/3}O₂, spinel-type active materials such as LiMn₂O₄, Li₄Ti₅O₁₂, and olivine-type active materials such as LiFePO₄.

Examples of the conductive material include a carbon material. Examples of the carbon material include particulate carbon materials such as acetylene black (AB) and Ketjen black (KB); and fibrous carbon materials such as carbon fibers, carbon nanotubes (CNT), and carbon nanofibers (CNF). The solid electrolyte and the binder are similar to those described in “1. Solid Electrolyte Layer.”

Examples of the positive electrode current collector include SUS, aluminum, nickel, and carbon. Examples of the shape of the positive electrode current collector include a foil shape. The thickness of the positive electrode current collector is, for example, 1 μm or more and 500 μm or less.

### 3. Negative Electrode

The negative electrode in the present disclosure includes at least a negative electrode current collector. Further, for example, as shown in FIG. 3, the negative electrode 1 may include, for example, Mg layers 6 to be described later. On the other hand, it is preferable that the negative electrode does not include a negative electrode active material layer containing negative electrode active material particles.

Examples of the negative electrode current collector include SUS, copper, nickel, and carbon. Examples of the shape of the negative electrode current collector include a foil shape. The thickness of the negative electrode current collector is, for example, 1 μm or more and 500 μm or less.

As shown in FIG. 1, the negative electrode current collector 1 may be in direct contact with the solid electrolyte layer 2A. On the other hand, as shown in FIG. 3, a Mg layer including Mg may be disposed between the negative electrode current collector 1 and the solid electrolyte layer 2A. By providing Mg layers, the cycling properties are further improved. Mg layers may contain Mg metals (single Mg) or Mg alloys (alloys containing Mg as a main component).

Mg layers are preferably in close contact with the negative electrode current collector. That is, Mg layers are preferably arranged so as to cover the surface of the negative electrode current collector. In some cases, the member including the negative electrode current collector and Mg layers disposed on the negative electrode current collector is referred to as a coated current collector. In the coated current collector, Mg layers and the negative electrode current collector may be in direct contact with each other or may be disposed via other layers. On the other hand, Mg layer and the solid electrolyte layer A may be in direct contact with each other or may be disposed via another layer.

Mg layers are, for example, thin films and are preferably vapor-deposited films. The thickness of Mg layers is not particularly limited, but is, for example, 30 nm or more. On the other hand, the thickness of Mg layers may be, for example, 2000 nm or less, or 1500 nm or less. Mg layers can be formed by, for example, a vapor deposition method such as vacuum-deposition.

Mg layers may not contain Li and may contain Li. The former corresponds to, for example, the state of Mg layers in the all-solid-state battery prior to the initial charge, and the latter corresponds to, for example, the state of Mg layers in the all-solid-state battery after the initial charge. Due to the initial charge, Mg contained in Mg layers is alloyed with Li when Li is introduced into the Mg layers. As a result, an alloy phase such as a Mg—Li alloy phase is formed in Mg layers. On the other hand, during discharging, Li moves from Mg layers alloyed with Li toward the positive electrode. Further, although not particularly illustrated, the protective layer described above may be disposed between Mg layer and the solid electrolyte layer A. In addition, a Li phase may be formed inside Mg layers. Further, a deposited Li layer may be formed between Mg layer and the solid electrolyte layer A. In addition, a deposited Li layer may be formed between Mg layer and the negative electrode current collector.

### 4. All-Solid-State Battery

As shown in FIG. 2, the all-solid-state battery 10 may have a protective layer 5 including Li and M (M is at least one of Sn, Al, Zn, In, Ge, Si, Sb, Ga, and Bi) between the negative electrode current collector 1 and the solid electrolyte layer 2A. The protective layer 5 usually includes an alloy phase such as a LiM alloy phase. The protective layer 5 may contain a residue component of the sulfide solid electrolyte. Examples of the residue components of the sulfide solid electrolyte include a compound containing an element P and an element Li, and a compound containing an element S and an element Li (for example, Li₂S). The thickness of the protective layers is not particularly limited, but is, for example, not less than 5 nm and not more than 100 nm. A Li phase may be formed inside the protective layers. In addition, a deposited Li layer may be formed between the protective layer and the solid electrolyte layer A. In addition, a deposited Li layer may be formed between the protective layer and the negative electrode current collector.

Applications of the all-solid-state battery of the present disclosure are not particularly limited, and examples thereof include power sources of vehicles such as hybrid electric vehicle (HEV), plug-in hybrid electric vehicle (PHEV), battery electric vehicle (BEV), gasoline-powered vehicles, and diesel-powered vehicles. In particular, it is preferably used as a power supply for driving hybrid electric vehicle (HEV), plug-in hybrid electric vehicle (PHEV) or battery electric vehicle (BEV). In addition, the all-solid-state battery may be used as a power source for a moving object (for example, a railway, a ship, or an aircraft) other than a vehicle, or may be used as a power source for an electric product such as an information processing apparatus.

In addition, the present disclosure can also provide the above-described method for manufacturing an all-solid-state battery. Specifically, the present disclosure can also provide a method of manufacturing an all-solid-state battery having a preparation step and a charging step. In the preparation step, an all-solid-state battery before the initial charging is prepared, which has the negative electrode current collector, the solid electrolyte layer A, the solid electrolyte layer B, and the positive electrode active material layer in this order in the thickness direction. In the charging step, the all-solid-state battery before the initial charging is charged. The solid electrolyte layer A contains a first sulfide solid electrolyte and a second sulfide solid electrolyte. The solid electrolyte layer B contains a third sulfide solid electrolyte. The first sulfide solid electrolyte is a sulfide solid electrolyte having a reduction peak at 0.3 V (vsLi/Li⁺) or more and 1.0 V (vsLi/Li⁺) or less in the cyclic voltammetry measurement. The first sulfide solid electrolyte contains an M element (M is at least one of Sn, Al, Zn, In, Ge, Si, Sb, Ga, and Bi). The second sulfide solid electrolyte is a sulfide solid electrolyte having no reduction peak at 0.3 V (vsLi/Li⁺) or more and 1.0 V (vsLi/Li⁺) or less in the cyclic voltammetry measurement. In the solid electrolyte layer A, the proportion of the first sulfide solid electrolyte in relation to the total weight of the first sulfide solid electrolyte and the second sulfide solid electrolyte is more than 0 wt % and 45 wt % or less. By the charging step, a protective layer including Li and M is formed between the negative electrode current collector and the solid electrolyte layer A.

Note that the present disclosure is not limited to the above-described embodiment. The above embodiments are illustrative, and anything having substantially the same configuration as, and having similar functions and effects to, the technical idea described in the claims of the present disclosure is included in the technical scope of the present disclosure.

### Example 1

### Preparation of Sulfide Solid Electrolyte

As starting materials for the first sulfide solid electrolyte, Li₂S, P₂S₅ and SnS₂ were prepared. These starting materials were subjected to ball mill mixing (mechanical milling) and calcination to obtain a Li₁₀SnP₂S₁₂ (first sulfide solid electrolyte) having a LGPS crystalline phase. Next, Li₂S, P₂S₅ and LiI were prepared as starting materials for the second sulfide solid electrolyte. These starting materials were ball milled (mechanical milling) and calcined to give a LiI-containing Li₃PS₄ (second sulfide solid electrolyte).

### Preparation of Composite Material for Solid Electrolyte Layer

The first sulfide solid electrolyte and the second sulfide solid electrolyte were weighed so that the proportion of the first sulfide solid electrolyte in relation to the total weight of the first sulfide solid electrolyte and the second sulfide solid electrolyte was 10 wt %, and the first sulfide solid electrolyte and the second sulfide solid electrolyte were mixed in a mortar. As a result, a mixture for the solid electrolyte layer A was obtained. The second sulfide solid electrolyte was prepared as a sulfide solid electrolyte for the solid electrolyte layer B.

### Preparation of Positive Electrode

To a polypropylene container, butyl butyrate, a 5 wt % butyl butyrate solution of a polyvinylidene fluoride-based binder, lithium nickel cobalt aluminum oxide, the second sulfide solid electrolyte, and vapor-grown carbon fiber (VGCF) were added. Polypropylene containers are described as PP containers. Vapor grown carbon-fiber (VGCF) is a conductive material. The lithium nickel cobalt aluminum oxide is a positive electrode active material. The volume ratio of the positive electrode active material to the second sulfide solid electrolyte was positive electrode active material:second sulfide solid electrolyte=75:25. Next, PP container was stirred for 30 seconds by an ultrasonic dispersing device (UH-50 manufactured by SMT). Next, PP container was shaken with a shaker (manufactured by Shibata Scientific Co., Ltd., TTM-1) for 30 minutes to obtain a slurry for the positive electrode active material layers. Thereafter, the slurry was applied onto an Al foil (positive electrode current collector) by a blade method using an applicator. Thereafter, the mixture was dried naturally and dried on a hot plate at 100° C. for 30 minutes. Thus, a positive electrode having a positive electrode current collector and a positive electrode active material layer was obtained.

### Preparation of Negative Electrode Current Collector

A Ni foil was prepared as a negative electrode current collector. Mg was deposited on Ni foil to form Mg layers (thickness 1000 nm). Thus, a negative electrode current collector having Mg layers was obtained.

### Cell Fabrication

The second sulfide solid electrolyte 50 mg for the solid electrolyte layer B was placed in a tube made of Macor and having an area 1 cm², and pressed at 1 ton/cm² to form the solid electrolyte layer B. Next, a mixture 50 mg for the solid electrolyte layer A was placed on the solid electrolyte layer B, and pressed at 1 ton/cm² to form the solid electrolyte layer A. Next, a positive electrode was disposed on the surface of the solid electrolyte layer B so that the positive electrode active material layer was opposed to the solid electrolyte layer B, and pressed at a 1 ton/cm². Next, a negative electrode current collector was disposed on the surface of the solid electrolyte layer A so that Mg layer was opposed to the solid electrolyte layer A, and pressed at a 6 ton/cm². The positive electrode terminal and the negative electrode terminal were connected to the laminate obtained by pressing, and the cell was obtained by restraining at 2 N m. The number of layers of the solid electrolyte layer in the obtained cell is 2.

### Example 2

A cell was obtained in the same manner as in Example 1, except that a mixture in which the proportion of the first sulfide solid electrolyte in relation to the total weight of the first sulfide solid electrolyte and the second sulfide solid electrolyte was 30 wt % was used as the mixture for the solid electrolyte layer A. Cells were obtained. The number of layers of the solid electrolyte layer in the obtained cell is 2.

### Example 3

A cell was obtained in the same manner as in Example 1, except that a mixture in which the proportion of the first sulfide solid electrolyte in relation to the total weight of the first sulfide solid electrolyte and the second sulfide solid electrolyte was 40 wt % was used as the mixture for the solid electrolyte layer A. Cells were obtained. The number of layers of the solid electrolyte layer in the obtained cell is 2.

### Comparative Example 1

The quantity of the mixture used for the solid electrolyte layer A was changed from 50 mg to 100 mg. As a mixture for the solid electrolyte layer A without forming the solid electrolyte layer B, a mixture in which the proportion of the first sulfide solid electrolyte in relation to the total weight of the first sulfide solid electrolyte and the second sulfide solid electrolyte was 0 wt % was used. A cell was obtained in the same manner as in Example 1 except for the above. The number of layers of the solid electrolyte layer in the obtained cell is 1.

### Comparative Example 2

A cell was obtained in the same manner as in Comparative Example 1, except that a mixture in which the proportion of the first sulfide solid electrolyte in relation to the total weight of the first sulfide solid electrolyte and the second sulfide solid electrolyte was 40 wt % was used as the mixture for the solid electrolyte layer A. The number of layers of the solid electrolyte layer in the obtained cell is 1.

### Comparative Example 3

A cell was obtained in the same manner as in Comparative Example 1, except that a mixture in which the proportion of the first sulfide solid electrolyte in relation to the total weight of the first sulfide solid electrolyte and the second sulfide solid electrolyte was 50 wt % was used as the mixture for the solid electrolyte layer A. The number of layers of the solid electrolyte layer in the obtained cell is 1.

### Comparative Example 4

A cell was obtained in the same manner as in Comparative Example 1, except that a mixture in which the proportion of the first sulfide solid electrolyte in relation to the total weight of the first sulfide solid electrolyte and the second sulfide solid electrolyte was 100 wt % was used as the mixture for the solid electrolyte layer A. The number of layers of the solid electrolyte layer in the obtained cell is 1.

### Comparative Example 5

A cell was obtained in the same manner as in Example 1, except that a mixture in which the proportion of the first sulfide solid electrolyte in relation to the total weight of the first sulfide solid electrolyte and the second sulfide solid electrolyte was 50 wt % was used as the mixture for the solid electrolyte layer A. The number of layers of the solid electrolyte layer in the obtained cell is 2.

### Reference Example 1

A cell was obtained in the same manner as in Comparative Example 1, except that a mixture in which the proportion of the first sulfide solid electrolyte in relation to the total weight of the first sulfide solid electrolyte and the second sulfide solid electrolyte was 5 wt % was used as the mixture for the solid electrolyte layer A. The number of layers of the solid electrolyte layer in the obtained cell is 1.

### Reference Example 2

A cell was obtained in the same manner as in Comparative Example 1, except that a mixture in which the proportion of the first sulfide solid electrolyte in relation to the total weight of the first sulfide solid electrolyte and the second sulfide solid electrolyte was 10 wt % was used as the mixture for the solid electrolyte layer A. The number of layers of the solid electrolyte layer in the obtained cell is 1.

### Reference Example 3

A cell was obtained in the same manner as in Comparative Example 1, except that a mixture in which the proportion of the first sulfide solid electrolyte in relation to the total weight of the first sulfide solid electrolyte and the second sulfide solid electrolyte was 30 wt % was used as the mixture for the solid electrolyte layer A. The number of layers of the solid electrolyte layer in the obtained cell is 1.

### Evaluation

### Cyclic Voltammetry Measurement

Cyclic voltammetry (CV) was measured using the first sulfide solid electrolyte (Li₁₀SnP₂S₁₂) and the second sulfide solid electrolyte (Li₃PS₄ containing LiI) synthesized in Example 1. As a sample for measurement, a mixture of a sulfide solid electrolyte and a conductive material (VGCF) was placed on a stainless-steel (SUS), and a sample (thickness 1 mm) in which a Li foil was laminated on the mixture was prepared, and CV measurement was performed 1 mV/sec a sweep rate. As a result, it was confirmed that the first sulfide solid electrolyte (Li₁₀SnP₂S₁₂) had a reduction peak at 0.3 V (vsLi/Li⁺) or more and 1.0 V (vsLi/Li⁺) or less. It was also confirmed that the second sulfide solid electrolyte (Li₃PS₄ containing LiI) had no reduction peak at 0.3 V (vsLi/Li⁺) or more and 1.0 V (vsLi/Li⁺) or less.

### Evaluation of Cycle Characteristics

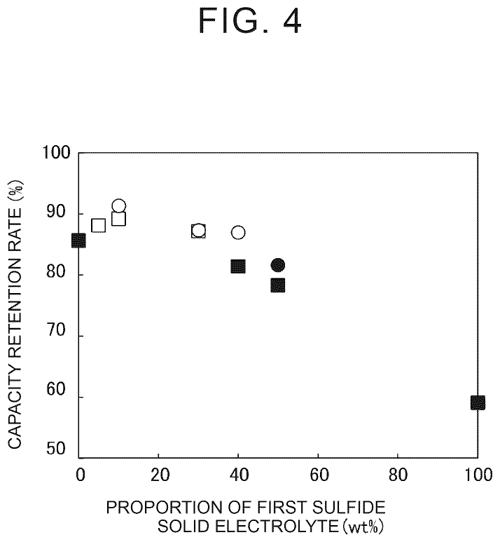

For the cells obtained in Examples, Comparative Examples, and Comparative Examples, a charge and discharge measurement was performed at a temperature of 25° C. in the voltage range of 3.0 V to 4.2 V in a CCCV mode at a current value of 0.6 mA/cm² (0.03 mA/cm² cut). The capacity retention rate (%) was determined from the discharge capacity of the first cycle and the discharge capacity of the 20th cycle. The results are shown in Table 1 and FIG. 4.

TABLE 1

| | | | Discharge | Discharge | |
|---|---|---|---|---|---|
| | Number | Proportion | Capacity | Capacity | Capacity |
| | of | (wt %) of First | (mAh/g) at | (mAh/g) at | Retention |
| | layers | Sulfide SE | First Cycle | 20th cycle | Rate (%) |
| Comparative | 1 | 0 | 132 | 113 | 85.6 |
| Example 1 | | | | | |
| Reference | 1 | 5 | 143 | 126 | 88.1 |
| Example 1 | | | | | |
| Reference | 1 | 10 | 148 | 132 | 89.2 |
| Example 2 | | | | | |
| Reference | 1 | 30 | 140 | 122 | 87.1 |
| Example 3 | | | | | |
| Comparative | 1 | 40 | 129 | 105 | 81.4 |
| Example 2 | | | | | |
| Comparative | 1 | 50 | 120 | 94 | 78.3 |
| Example 3 | | | | | |
| Comparative | 1 | 100 | 110 | 65 | 59.1 |
| Example 4 | | | | | |
| Example 1 | 2 | 10 | 150 | 137 | 91.3 |
| Example 2 | 2 | 30 | 142 | 124 | 87.3 |
| Example 3 | 2 | 40 | 138 | 120 | 87.0 |
| Comparative | 2 | 50 | 125 | 102 | 81.6 |
| Example 5 | | | | | |

As shown in Table 1 and FIG. 4, it was confirmed that Examples 1 to 3 had a high capacity retention rate and good cycle characteristics compared to Comparative Examples 1 to 4. In comparison with Comparative Example 1 and Comparative Example 4, the capacity retention rate of Comparative Example 4 was significantly lower than that of Comparative Example 1. This is presumed to be because the reduction resistance of the first sulfide solid electrolyte (Li₁₀SnP₂S₁₂) is lower than that of the second sulfide solid electrolyte (Li₃PS₄ including LiI). On the other hand, when comparing Comparative Example 1 and Reference Examples 1 to 3, in Reference Examples 1 to 3, the capacity retention rate was higher than that of Comparative Example 1 in spite of including the first sulfide solid electrolyte having relatively low reduction resistance. This is presumed to be because the reactants of the first sulfide solid electrolyte and Li (in particular, LiM alloys) functioned as protective layers. In comparison with Comparative Examples 1 and 2 and 3, the capacity retention rate of Comparative Examples 2 and 3 was lower than that of Comparative Example 1. This is presumed to be because the reactants of the first sulfide solid electrolyte and Li reversely functioned as resistive layers.

Compared with Example 1 and Reference Example 2, Example 1 had a higher capacity retention rate than Reference Example 2. Similarly, when Example 2 and Reference Example 3 were compared, the capacity retention rate of Example 2 was slightly higher than that of Reference Example 3. As described above, it was confirmed that even when the solid electrolyte layer is composed of a plurality of layers and the first sulfide solid electrolyte having relatively low reduction resistance is unevenly distributed in the layer on the negative electrode current collector side, a good capacity retention rate can be obtained.

Comparing Reference Example 1 and Comparative Example 1, the capacity retention rate of Reference Example 1 was higher than that of Comparative Example 1. As a result, and from the tendencies of Examples 1 and 2 and Reference Examples 2 and 3 described above, it was suggested that a good capacity retention rate can be obtained in the following cases. The following case is a case in which the solid electrolyte layer has the solid electrolyte layer A and the solid electrolyte layer B, and in the solid electrolyte layer A, the proportion of the first sulfide solid electrolyte in relation to the total weight of the first sulfide solid electrolyte and the second sulfide solid electrolyte is 5 wt %. Further, in comparison with Comparative Example 3 and Comparative Example 5, the capacity retention rate of Comparative Example 5 was higher than that of Comparative Example 3, but was higher than that of Comparative Example 1. This is presumed to be because, as described above, the reactants of the first sulfide solid electrolyte and Li reversely functioned as resistive layers.

### Reference Example 4

### Preparation of Sulfide Solid Electrolyte

In the same manner as in Example 1, a Li₃PS₄ containing LiI (second sulfide solid electrolyte) was obtained.

### Preparation of Solid Electrolyte Layer

To a polypropylene container (PP container), heptane, a 5 wt % heptane solution of a polyvinylidene fluoride-based binder, and the second sulfide solid electrolyte were added. Next, PP container was stirred for 30 seconds by an ultrasonic dispersing device (UH-50 manufactured by SMT). Next, PP container was shaken with a shaker (TTM-1, manufactured by Shibata Scientific Co., Ltd.) for 30 minutes to obtain a slurry for the solid electrolyte layer. The slurry was then applied to PET films by a blade process using applicators. Thereafter, the mixture was dried naturally and dried on a hot plate at 100° C. for 30 minutes. After drying, two coated solid electrolyte layers were prepared, bonded together, and pressed at 7 ton/cm². After pressing, PET films were peeled off to obtain self-supporting solid electrolyte layers. Further, a Sn layer (thickness 100 nm) was formed on one side of the solid electrolyte layer by a sputtering method.

### Preparation of Positive Electrode

A positive electrode was obtained in the same manner as in Example 1.

### Preparation of Negative Electrode Current Collector

In the same manner as in Example 1, a negative electrode current collector having Mg layers was obtained.

### Cell Fabrication

The negative electrode current collector having Mg layers and the solid electrolyte layer having Sn layers were each punched to @14.5 mm. Next, the negative electrode current collector and the solid electrolyte layer were laminated so that Mg layer and Sn layer were opposed to each other. Then, a positive electrode punched to @11.28 mm was placed on the solid electrolyte layer. The positive electrode terminal and the negative electrode terminal were connected to the obtained laminate and sealed with a laminate film. The sealed laminate was subjected to cold isotropic pressure (CIP) treatment at a 392 MPa pressure, and then CIP treated laminate was restrained at a 1 MPa pressure using a metallic plate to obtain a cell.

### Reference Examples 5 to 7

A cell was obtained in the same manner as in Reference Example 4, except that sputtering of Al, Zn or In was performed instead of sputtering of Sn at the time of preparing the solid electrolyte layer.

### Reference Example 8

A cell was obtained in the same manner as in Reference Example 4, except that no sputtering was performed at the time of preparing the solid electrolyte layer.

### Evaluation

Charge and discharge measurements were performed on the cells obtained in each reference example in the same manner as described above, and the capacity retention rate (%) was determined. The test results are shown in Table 2.

TABLE 2

| | | | Discharge | |
|---|---|---|---|---|
| | | Discharge capacity | capacity | Capacity |
| | | (mAh/g) at the | (mAh/g) at | retention |
| | Metal | first cycle | 20th cycle | rate (%) |
| Reference | Sn | 156 | 140 | 89.7 |
| Example 4 | | | | |
| Reference | Al | 166 | 139 | 83.7 |
| Example 5 | | | | |
| Reference | Zn | 148 | 135 | 91.2 |
| Example 6 | | | | |
| Reference | In | 155 | 130 | 83.9 |
| Example 7 | | | | |
| Reference | None | 158 | 20 | 12.7 |
| Example 8 | | | | |

As shown in Table 2, it was confirmed that Reference Examples 4 to 7 had a higher capacity retention rate and better cycle characteristics than Reference Example 8. The metals used in Reference Examples 4 to 7 are all metals that can be alloyed with Li, and are alloyed with Li at the time of charge, and are presumed to have increased capacity retention by functioning as protective layers. This suggests that good cycle characteristics can also be obtained even when the first sulfide solid electrolyte contains the metal.

What is claimed is:

1. An all-solid-state battery using a precipitation-dissolution reaction of metallic lithium as a negative electrode reaction, comprising a negative electrode current collector, a solid electrolyte layer A, a solid electrolyte layer B, and a positive electrode active material layer in this order in a thickness direction, wherein:
the solid electrolyte layer A contains a first sulfide solid electrolyte and a second sulfide solid electrolyte;
the solid electrolyte layer B contains a third sulfide solid electrolyte;
the first sulfide solid electrolyte is a sulfide solid electrolyte having a reduction peak at 0.3 V (vsLi/Li⁺) or more and 1.0 V (vsLi/Li⁺) or less in a cyclic voltammetry measurement, and the first sulfide solid electrolyte contains an M element (M is at least one of the following elements: Sn, Al, Zn, In, Ge, Si, Sb, Ga, and Bi);
the second sulfide solid electrolyte is a sulfide solid electrolyte having no reduction peak at 0.3 V (vsLi/Li⁺) or more and 1.0 V (vsLi/Li⁺) or less in the cyclic voltammetry measurement; and
in the solid electrolyte layer A, a proportion of the first sulfide solid electrolyte in relation to a total weight of the first sulfide solid electrolyte and the second sulfide solid electrolyte is more than zero percent by weight and 45 percent by weight or less.

2. The all-solid-state battery according to claim 1, wherein, in the solid electrolyte layer A, the proportion of the first sulfide solid electrolyte in relation to the total weight of the first sulfide solid electrolyte and the second sulfide solid electrolyte is five percent by weight or more and 40 percent by weight or less.

3. The all-solid-state battery according to claim 1, wherein the third sulfide solid electrolyte is a sulfide solid electrolyte having no reduction peak at 0.3 V (vsLi/Li⁺) or more and 1.0 V (vsLi/Li⁺) or less in the cyclic voltammetry measurement.

4. The all-solid-state battery according to claim 1, wherein:
the first sulfide solid electrolyte contains an Li element, the M element, and an S element; and
the M element is at least one of the following elements: Sn, Al, Zn, and In.

5. The all-solid-state battery according to claim 1, wherein the all-solid-state battery includes a protective layer between the negative electrode current collector and the solid electrolyte layer A, the protective layer containing Li and the M.
